(19) United States
(12) Patent Application Publication
(10) Pub. No.: US 2006/0143391 A1
(43) Pub. Date: Jun. 29, 2006

(54) Computer device

(75) Inventors: Carsten Mielenz, Chandler, AZ (US); Hans-Georg Gruber, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/280,937

(22) Filed: Nov. 15, 2005

(30) Foreign Application Priority Data
Nov. 15, 2004 (DE) 10 2004 055 013.1

(51) Int. Cl. G06F 12/00

(52) U.S. Cl. 711/130

(57) ABSTRACT

A computer device having a plurality of system components which access a common memory. For memory access, a common buffer store is provided which increases access and can be matched to the memory.

### CROSS-REFERENCE TO RELATED APPLICATION

This application claims priority to German Patent Application Serial No. 10 2004 055 013.1, which was filed on Nov. 15, 2004, and is incorporated herein by reference in its entirety.

### FIELD OF THE INVENTION

The invention relates to a computer device.

### BACKGROUND OF THE INVENTION

Mobile electronic apparatuses, such as PDAs (Personal Digital Assistants) and other electronic apparatuses which are equipped with a microprocessor, typically have just a small internal memory for reasons of cost.

Normally, program instructions and data for applications for these mobile apparatuses are stored on external memory apparatuses which are coupled to the mobile apparatuses.

Such external memory apparatuses can be used to store a large volume of data, typically between 100 kilobytes and 256 megabytes. However, the access time for the external memory apparatuses is very long in comparison with an internal memory. By way of example, the access time for an external memory contained in an external memory apparatus may be 80 times longer than the access time for an internal memory in the mobile apparatus. External memories arranged in external memory apparatuses are accessed using a control device integrated in the mobile apparatus. The control device can normally serve a plurality of masters, as explained below with reference to FIG. 1.

FIG. 1 shows a known memory arrangement 100.

A mobile apparatus 101 is coupled to an external memory 102.

The mobile apparatus has a plurality of masters 103, 104, 105. The masters 103, 104, 105 use a memory control unit 106 to access an external memory 102.

The masters may be, by way of example, a central processing unit (CPU), a digital signal processor (DSP), a DMA (Direct Memory Access) unit or the like.

Since the access time to the external memory 102 can be very high, for example 100 ns, as mentioned, in this example each master 103, 104, 105 is respectively equipped with a buffer store (cache) 107, 108, 109. The buffer stores 107, 108, 109 typically have a short access time, for example 10 ns, which means that buffer-storage achieves overall faster access to data which are stored in the external memory 102.

However, the buffer stores 107, 108, 109 are able to cooperate with the external memory only poorly, since, by way of example, the bus which is used to couple the external memory 102 to the mobile apparatus 101 is incompatible (for example in terms of bus width) with the bus used by the buffer stores 107, 108, 109 for communication with the memory control unit 106.

A licence agreement might prohibit a manufacturer of the mobile apparatus 101 from matching the buffer stores 107, 108, 109 to the bus which is used to couple the external memory 102 to the mobile apparatus 101.

In addition, problems may arise when a plurality of the masters 103, 104, 105 access the same data in the external memory 102 and possibly alter them. In this case, one master 103, 104, 105 has to wait for data which are being altered beforehand by another master 103, 104, 105, i.e. has to wait until the data are stored back in the external memory 102 from the respective buffer store 107, 108, 109 in the master which has altered the data. In this case, the speed advantage which was achieved, particularly by the use of a buffer store 107, 108, 109, in terms of access to the external memory 102 is lost.

Further speed drawbacks arise when a cache flush is performed for a reason, i.e. the data stored in a buffer store 107, 108, 109 are written to the external memory 102. Such cache flushes may be prompted, by way of example, by the operating system of the mobile apparatus 101, for example Windows Mobile, since it is not possible to access the external memory 102 in another way for the duration of the cache flush.

U.S. Pat. No. 6,405,322 B1 describes a computer system in which a plurality of processors access a buffer store which serves as a cache for a common main memory. The buffer store is coupled to the plurality of processors by means of a first bus and to the common main memory by means of a second bus.

The problem underlying the invention is to eliminate the above drawbacks, and, in particular, to provide an arrangement which allows efficient access to one memory by a plurality of masters.

### SUMMARY OF THE INVENTION

A computer device having a plurality of system components, a memory, and a memory control unit having a buffer store, which respectively has at least one interface to each of the plurality of system components, and which is coupled to the memory and is set up to buffer-store data which are stored or to be stored in the memory during data transfers between the plurality of system components and the memory. Each of the plurality of system components is set up to use the interface to access the buffer store, and is coupled to the memory and is set up for read access and/or write access to the memory using the memory control unit.

### BRIEF DESCRIPTION OF THE DRAWINGS

Exemplary embodiments of the invention are illustrated in the figures and are explained in more detail below.

FIG. 1 shows a known memory arrangement.

FIG. 2 shows a memory arrangement based on an exemplary embodiment of the invention.

FIG. 3 shows a memory arrangement based on a further exemplary embodiment of the invention.

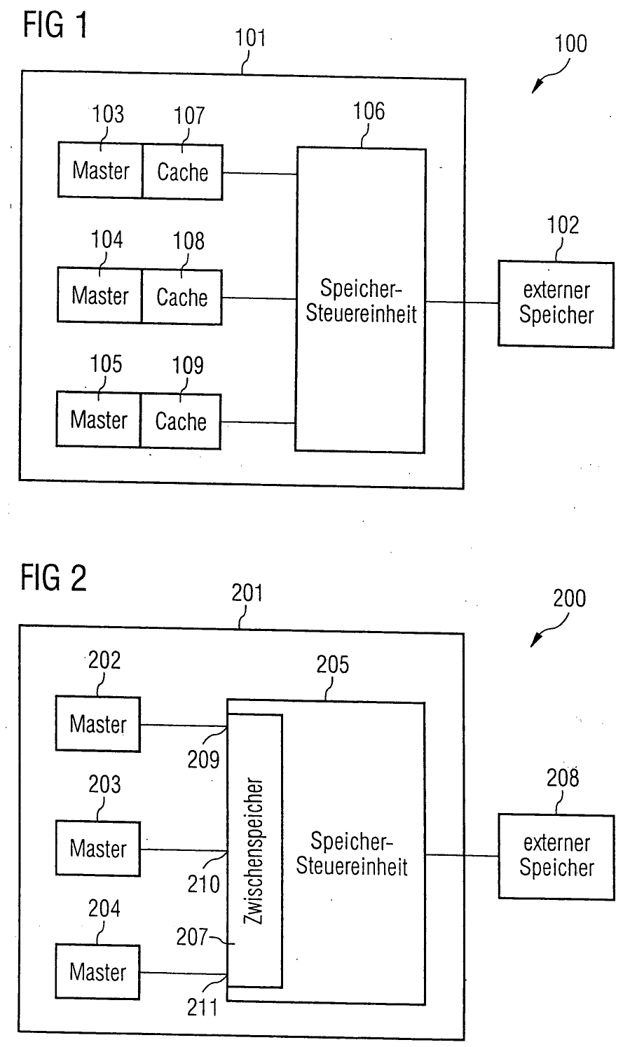

### DETAILED DESCRIPTION OF PREFERRED EMBODIMENTS OF THE INVENTION

The invention provides a computer device having a plurality of system components, a memory and a buffer store, where each of the plurality of system components is coupled to the memory and is set up for read access and/or write access to the memory. The buffer store respectively has at least one interface to each of the plurality of system components, each of the plurality of system components being set up to use the interface to access the buffer store. The buffer store is coupled to the memory and is set up to buffer-store data which are stored or to be stored in the memory in the course of data transfers between the plurality of system components and the memory.

An idea underlying the invention can clearly be seen in that not every one of the system components (clearly masters in the memory) is provided with a dedicated buffer store (cache), but rather a common buffer store for the system components is provided for accessing the memory. Accordingly, the buffer store has an interface, in other words a port, for each of the system components.

In one embodiment, the buffer store has a dedicated communication link, for example, that is to say a dedicated computer bus, to each of the system components. This means that the system components do not use a common computer bus to communicate with the buffer store.

In another embodiment, the system components are coupled to the buffer store by means of a common computer bus.

The system components are components of a mobile apparatus, such as a laptop, a PDA (Personal Digital Assistant) or a mobile radio subscriber terminal.

Accordingly, the system components are, by way of example, a central processing unit (CPU), a digital signal processor or a unit for direct memory access, i.e. a DMA (Direct Memory Access) unit.

By way of example, the memory is an external memory which is coupled to the mobile apparatus.

The use of a common buffer store for the plurality of system components allows inexpensive matching to the memory or to the bus which the system components use to access the memory.

By way of example, the width of the memory rows in the buffer store may have been matched to the width of the bus, so that a memory row in the buffer store can be loaded by accessing the memory a single time.

In addition, the buffer store can be set up such that it loads memory rows or memory columns from the memory, depending on what type of access the memory better supports.

Clearly, long access times are avoided at the source, the memory, of the long access times, by using a buffer store which has been matched especially to the memory (and/or bus).

Access to the memory is clearly optimized, that is to say that the buffer store is set up such that access to the memory is optimized, in terms of access time and/or data throughput rate, by the plurality of system components.

The coupling between the buffer store and the memory is made by means of a standard interface, for example, that is to say an ordinary interface.

As mentioned, the prior art does not readily allow a buffer store in a system component, that is to say the buffer store belonging to a system component (for example a level 1 cache in a CPU), to be matched to the memory and/or to the bus. By way of example, this may be prohibited by a licence agreement, or matching may be very complex or even impossible. In addition, a considerable (cost) involvement would be required for matching the buffer stores in all system components.

Using the computer device provided also does not produce the problem outlined above, which arises when one of the system components alters data and another system component has to wait until the altered data are written back to the memory, which requires a large number of clock cycles. In the case of the computer device provided, one system component alters the data in the (common) buffer store and another system component can access the altered data immediately without there being a need to access the memory. This results in a considerable gain in speed, and parallel access by the system components to the data stored in the memory is clearly improved.

It is preferred for the computer device also to have a memory access unit which is connected between the plurality of system components and the memory and which is used to perform the read access operations and/or memory access operations of the plurality of system components.

Preferably, the buffer store is managed by the memory access unit.

Clearly, the buffer store is preferably part of the memory access unit.

It is also preferred for the plurality of system components to be respectively coupled to the memory by means of a computer bus and for the buffer store to have been matched to these computer buses.

By way of example, the buffer store, or a control unit in the buffer store, for example the memory access unit, may be coupled to the arbitration units (bus arbiters) of the computer buses and may contain information from these, for example whether the respective system component is currently accessing the respective computer bus. In this way, it is possible for the buffer store or the control unit always to know which system components are accessing the buffer store and/or which area of the buffer store the system components are accessing (want to access). This provides a simple way of resolving conflicts which arise in the event of access by a plurality of system components.

It is also preferred for the buffer store to have been matched to the memory.

Preferably, the buffer store has been matched to the data word length of the memory.

The buffer store may have been matched to the memory in terms of the memory row width of the buffer store being as large as (or else larger than) the memory cell width of the memory. It is thus possible to load a complete memory row (or else a plurality of complete memory rows) from the external memory into a memory row in the buffer store.

The buffer store may also have been matched to the memory in terms of refresh rate.

The buffer store is preferably an n-set associative cache, a fully associative cache or a direct-mapped cache.

The memory is preferably an SRAM (Static Random Access Memory), an SDRAM (Synchronous Dynamic Random Access Memory), an EPROM (Erasable Programmable Read Only Memory), or an EEPROM (Electrically Erasable Programmable Read Only Memory).

In one embodiment, the memory is external to the system components and the buffer store. That is to say that the system components and the buffer store (which is thus internal) are in a housing which is coupled to another housing, for example by means of a USB (Universal Serial Bus) plug connection, which contains the memory. The memory is thus clearly an independent memory unit.

It is also preferred for the buffer store to have been matched to the operating system of the computer device.

FIG. 2 shows a memory arrangement 200 based on an exemplary embodiment of the invention.

A mobile apparatus 201 has a first master 202, a second master 203 and a third master 204. In line with this exemplary embodiment of the invention, the mobile apparatus 201 is a PDA (Personal Digital Assistant), a portable computer (laptop) or a mobile radio subscriber terminal. The masters 202, 203, 204 are system components of the mobile apparatus 201, in line with this exemplary embodiment of the invention a central processing unit (CPU), a digital signal processor or a unit for direct memory access, i.e. a DMA (Direct Memory Access) unit.

The mobile apparatus 201 also has a memory control unit (memory controller) 205. The memory control unit 205 is coupled to a memory 208 which is external to the mobile apparatus 201 by means of a data bus 206 (a corresponding control bus is not shown).

The memory control unit 205 has a buffer store (cache) 207. Using the memory control unit 205, the masters 202, 203, 204 can access the memory 208, i.e. can store data in the memory 208 or read data from the memory 208.

The external memory 208 is an SRAM (Static Random Access Memory), an SDRAM (Synchronous Dynamic Random Access Memory), an EPROM (Erasable Programmable Read Only Memory), or an EEPROM (Electrically Erasable Programmable Read Only Memory), for example. In line with the refinement of the memory 202, the masters 202, 203, 204 may possibly read only data from the memory 208 and cannot store data in the memory 208.

The memory control unit 205 is designed on the basis of the memory 208 and is accordingly an access unit for an SDRAM memory or a flash controller, for example.

In line with the respective refinement, the external memory 208 and the memory control unit 205 are coupled to one another, for example by means of a cable, which allows data transmission from an SDRAM and to an SDRAM, based on USB (Universal Serial Bus) or other interface standards.

Using the buffer store 207, the access times for the masters 202, 203, 204 to access the memory 208 are reduced. By way of example, data which the first master 202 reads from the memory 208 are stored in the buffer store 207, so that when the data are read again by one of the masters 202, 203, 204 the access time to the data is significantly reduced.

The write access by the masters 202, 203, 204 to data stored in the buffer store 207 is performed using the write back method or the write through method, for example. The buffer store 207 is a fully associative cache, a direct-mapped cache or an n-set associative cache.

The masters 202, 203, 204 are designed on the basis of a system-on-chip (SoC) architecture, for example. The memory 208 can store any data and program instructions. By way of example, the memory 208 contains the program instructions for an application and data which are processed during the application, which is executed by one of the masters 202, 203, 204.

The first master 202 uses a first port 209 on the buffer store 207 to access the buffer store 207. The second master 203 uses a second port 210 to access the buffer store 207, and the third master 204 uses a third port 211 to access the buffer store 207. The buffer store 207 thus has a plurality of ports 209, 210, 211.

In another embodiment, the masters 202, 203, 204 use a common computer bus to access the buffer store 207, which has an interface to the common computer bus.

The buffer store 207 is set up in optimum fashion in terms of the memory 208, that is to say is matched to the memory 208. By way of example, in line with the refinement of the memory 208, memory rows in the memory 208 or memory columns in the memory 208 are buffer-stored in the buffer store 207. In addition, the size of the data blocks which are stored in the buffer store 207 when one of the masters 202, 203, 204 effects read access to the memory 208 has been matched to the memory 208. If the memory 208 has a memory cell width of 4 data words, for example, it would accordingly be possible to store the entire memory row containing the (data) word in the buffer store 207 when one of the masters 202, 203, 204 accesses a memory row in the memory 208.

In addition, the buffer store 207 may be optimized in terms of the computer bus 206, that is to say matched to the computer bus 206. If the bus width of the bus 206 is two data words, for example, then when one of the masters 202, 203, 204 effects read access to a data word which is stored in the memory 208 it is possible for precisely two data words, for example the data word which is accessed and the data word which is adjacent in the memory 208, to be transmitted to the buffer store 207 by means of the bus 206.

In addition, the buffer store 207 may be set up in optimum fashion in terms of the operating system of the mobile apparatus 201, and the memory control unit 205 may have been matched to the operating system, which means that, by way of example, flush processes, i.e. processes in which the entire content of the buffer store 207 is written back to the memory 208, and stall processes, i.e. processes in which the masters 202, 203, 204, for example, block one another, are avoided. The memory control unit 205 and the buffer store 207 may have been matched, by way of example, to the particular features of an open operating system, for example Linux.

By way of example, the operating system might have the particular feature that on certain occasions it prompts the content of the buffer store or part of the buffer store to be written back to the external memory and that this write-back is effected on the basis of a particular pattern, that is to say on the basis of a particular order of memory cells, for example. The memory control unit 205 could assist this write-back on the basis of the pattern which is specific to the operating system, so that the write-back can be performed efficiently.

In addition, the memory control unit 205 is set up to ensure the coherency of the buffer store 207 (cache coherency).

The memory control unit 205 may also be set up and controlled such that the data throughput rate is optimized for an application which is executed on the mobile apparatus 204. If the operating system of the mobile apparatus 201 is a real-time operating system (RTOS), the memory control unit 205 may be set up such that it maintains the real-time capability of the operating system even during memory access operations to the memory 208. In addition, the memory control unit 205 can perform driver tasks and, by way of example, can convert memory access commands from the masters 202, 203, 204 into appropriate instructions to the memory 208.

Clearly, the memory control unit 205 performs a multiplicity of tasks which relate to access to the memory 208 in the course of an application.

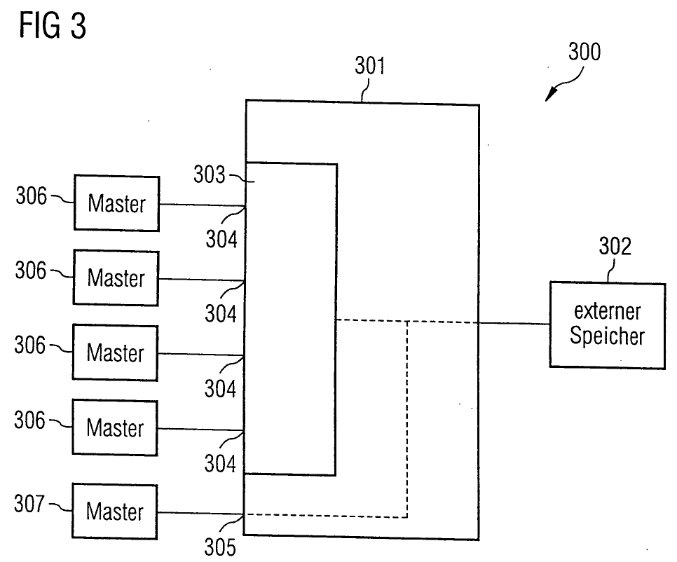

FIG. 3 shows a memory arrangement 300 based on a further exemplary embodiment of the invention.

In a similar manner to FIG. 2, a memory control unit 301, which is arranged in a mobile apparatus (not shown), for example, is coupled to a memory 302 which is external to the mobile apparatus.

In similar fashion to the above, the memory control device has a buffer store 303. The buffer store 303 has a plurality of ports 304 which can be used to couple the buffer store to a plurality of masters 306, 307. In contrast to the embodiment described with reference to FIG. 2, the memory control unit has a further port 305, which, in explicit terms, is coupled directly to the memory 302, i.e. is not coupled to the memory 302 by means of the buffer store 303.

By way of example, the further port 305 may be used to couple one of the masters 307 to the memory 302 without using the cache 303. This may be desired, for example, when the master 307 has an internal cache or when it is not necessary for the time which the master 307 requires to access the memory 302 to be short.

In another embodiment, the masters 306, 307, which are coupled to the memory control unit 301 by means of the ports 304, additionally have dedicated buffer stores. By way of example, one master 306, 307 could be a microprocessor which has a level 1 cache.

In the text below, an example is used to explain how the access time for memory access to a memory can be reduced by using a memory control unit as shown in FIG. 2 or FIG. 3.

Without the use of a buffer store, the simple formula below applies to the access time, expressed in clock cycles, for memory access:
per(without cache)=ExternalMemoryCycles where ExternalMemoryCycles denotes the number of clock cycles which are required for memory access to the memory.

When a memory control unit is used which, as FIG. 2 shows, for example, has a buffer store the formula below applies to the effective access time during memory access to the memory:
per(with cache)=Hit rate * 1 clock cycle+(1−hit rate) * ExternalMemoryCycles, where ExternalMemoryCycles, as above, denotes the number of clock cycles which is required for memory access to the memory, and hit rate denotes the probability of data which are accessed being stored in the buffer store. In this context, it is assumed that the access time for accessing the buffer store is one clock cycle, which is realistic in the case of a suitable buffer store.

If it is assumed that a realistic hit rate is 90% and ExternalMemoryCycles=50 clock cycles, for example, then the following values are obtained:
per(without cache)=50 clock cycles per(with cache)=0.9*1 clock cycles+(1−0.9)*50 clock cycles=5.9 clock cycles

What is claimed is:

1. A computer device comprising:
a plurality of system components;
a memory; and
a memory control unit having a buffer store, which respectively has at least one interface to each of the plurality of system components, and which is coupled to the memory and is set up to buffer-store data which are stored or to be stored in the memory during data transfers between the plurality of system components and the memory,
wherein each of the plurality of system components is set up to use the interface to access the buffer store, and is coupled to the memory and is set up for read access and/or write access to the memory using the memory control unit.

2. The computer device according to claim 1, wherein the plurality of system components are respectively coupled to the memory by dedicated computer buses, and where the buffer store has been matched to the computer buses.

3. The computer device according to claim 1, wherein the plurality of system components are coupled to the memory by a common computer bus, and where the buffer store is matched to the common computer bus.

4. The computer device according to claim 1, wherein the buffer store is matched to the memory.

5. The computer device according to claim 4, wherein the buffer store is matched to the data word length of the memory.

6. The computer device according to claim 1, wherein the buffer store is an n-set associative cache, a fully associative cache, or a direct-mapped cache.

7. The computer device according to claim 1, wherein the memory is an SDRAM, an SRAM, an EPROM, or an EEPROM.

8. The computer device according to claim 1, wherein the buffer store has been matched to the operating system of the computer device.

9. The computer device according to claim 1, further comprising a further interface, which is coupled directly to the memory.

10. A computer device comprising:
a plurality of system components;
a memory; and
a memory control means having a buffer store, which respectively has at least one interface to each of the plurality of system components, and which is coupled to the memory and is set up to buffer-store data which are stored or to be stored in the memory during data transfers between the plurality of system components and the memory,
wherein each of the plurality of system components is set up to use the interface to access the buffer store, and is coupled to the memory and is set up for read access and/or write access to the memory using the memory control means.
